(19) United States
(12) Patent Application Publication
(10) Pub. No.: US 2012/0206645 A1
(43) Pub. Date: Aug. 16, 2012

(54) DELIVERY SYSTEM, GATEWAY, DELIVERY METHOD, AND PROGRAM

(75) Inventor: Kazunori Ozawa, Tokyo (JP)

(73) Assignee: NEC CORPORATION, Tokyo (JP)

(21) Appl. No.: 13/503,510

(22) PCT Filed: Oct. 22, 2010
(86) PCT No.: PCT/JP2010/068668

§ 371 Date: Apr. 23, 2012

(30) Foreign Application Priority Data
Oct. 23, 2009 (JP) 2009-244549

(51) Int. Cl. H04N 11/02; H04N 7/01

(52) U.S. Cl. 348/425.3; 348/441; 348/E11.006; 348/E07.003

(57) ABSTRACT

Provided is a delivery system that responds to requests from various terminals and delivers content converted to be viewable/audible by the terminals. The delivery system includes a gateway that requests, if a temporary content accumulation apparatus does not store a moving image stream or moving image file receivable by a content-requesting-terminal, the external delivery server to transmit moving image content specified in a request message, generates a moving image stream or moving image file satisfying reception capability of the content-requesting-terminal, transmits the generated moving image stream or moving image file to the terminal, and stores the generated moving image stream or moving image file in the temporary content accumulation apparatus.

### REFERENCE TO RELATED APPLICATION

The present invention is based upon and claims the benefit of the priority of Japanese patent application No. 2009-244549, filed on Oct. 23, 2009, the disclosure of which is incorporated herein in its entirety by reference thereto.

The present invention relates to a delivery system, a gateway, a delivery method, and a program. In particular, it relates to: a delivery system including an accumulation apparatus temporarily accumulating moving image content; a gateway; a delivery method; and a program.

### TECHNICAL FIELD

### Background

Along with the increase in the speed and capacity of mobile networks, content delivery to mobile terminals is becoming more widespread. In addition, for example, as technology such as LTE (Long Term Evolution) and EPC (Evolved Packet Core) advances, mobile networks are expected to further improve in speed and capacity.

However, when content is delivered to mobile terminals, reception and display capabilities of mobile terminals need to be considered. For example, Patent Document 1 discloses a gateway server. If a requesting terminal is a small terminal, the gateway server converts content received from a content server so that the content matches the display capability of the small terminal. The gateway server then delivers the converted content.

In addition, Patent Document 2 discloses a server device analyzing a content transmission request transmitted from a client terminal, processing content so that the content matches screen display capability of the client terminal, and transmitting the processed content to the client terminal.

In addition, Patent Documents 3 and 4 disclose an application gateway. According to these documents, when a mobile terminal (UE) acquires content, an information management server (R2M: RADIUS & Repository Manager) generates profile information including user agent information about the mobile terminal, user information (User-Profile), self-care information (Selfcare-Profile), and mobile terminal information (UE-Profile). The application gateway refers to parameters in the profile information that represent performance and capability of the mobile terminal and converts the content acquired from an origin server in response to a content request (HTTP Req) transmitted from the mobile terminal, so that the performance and capability of the mobile terminal are utilized fully.

In addition, Patent Document 5 discloses a server that collects client attribute information and network band information, converts a stream delivering content into an optimum delivery encoding format and delivery bit rate, and transmits the converted stream.
Patent Document 1: Japanese Patent Kokai Publication No.JP2001-195330A
Patent Document 2: Japanese Patent Kokai Publication No.JP2001-236202A
Patent Document 3: Japanese Patent Kokai Publication No.JP2005-275534A
Patent Document 4: Japanese Patent Kokai Publication No.JP2005-277527A
Patent Document 5: Japanese Patent Kokai Publication No.JP2005-318057A

### SUMMARY

The entire disclosures of the above Patent Documents 1-5 are incorporated herein by reference thereto.

The following analyses are given by the present invention. As indicated in the above Patent Documents 1 to 5, when various terminals such as mobile phones, PDAs (Personal Digital Assistants), mobile PCs, and video game terminals receive and display content, if encoding information used when the content is encoded does not match capabilities of the terminals, it is difficult to execute decoding of the moving image stream. In such cases, the content may not be displayed or the image may be distorted. Further, if the bit rate, resolution, codec, file format, protocol, or the like does not match, decoding cannot be executed.

In the above Patent Documents 1 to 5, as countermeasures against this issue, a gateway or the like converts content. However, if the number of requesting terminals is large or if a flood of requests for popular content is transmitted from many terminals, the turn-around time (TAT) for delivery is extended. In addition, QoS (Quality of Service) of the mobile network between the delivery server and the terminals cannot be assured. As a result, since traffic is congested and packet loss is caused, serviceability is degraded, counted as a problem.

In addition, in Patent Document 1, since only whether the requesting terminal is a small terminal is considered, conversion suitable for each of the above terminals cannot be executed, counted as a problem. In addition, the techniques in Patent Documents 2 and 5 are described on the assumption that the client includes a function of transmitting screen display capability and attribute information (Patent Document 5 defines characteristics of an image/audio decoding unit or an image display/audio output unit as “attribute information.” See paragraph 0012). Namely, for terminals without a function of transmitting such information, necessary conversion cannot be executed, counted as a problem. In addition, according to Patent

Documents 3 and 4, profile information needs to be prepared for each user terminal, counted as a problem.

It is an object of the present invention to provide a delivery system, a gateway, a delivery method, and a program that can deliver content suitable for capability of each terminal, even when the number of requesting terminals is large or even when a flood of requests for certain content is transmitted from many terminals, and that there is no need for the terminals to transmit, for example, screen display capability, attribute information or the like.

According to a first aspect of the present invention, there is provided a delivery system comprising a gateway. The gateway comprises: a capability information storage unit storing information about a terminal type included in a content request message and capability information about moving image content reception capability of a terminal of the type, the information being associated with each other; a control signal transmission and reception unit extracting, based on capability information obtained from type information included in a request message supplied from a content-requesting-terminal via a packet transfer apparatus, a moving image stream or a moving image file receivable by the content-requesting-terminal from a predetermined temporary content accumulation apparatus; a conversion unit that, by referring to information stored in the capability information storage unit, executes necessary conversion on a moving image stream or a moving image file storing the moving image stream supplied from an external delivery server; and a packet transmission unit transmitting a moving image stream or a moving image file extracted from the predetermined temporary content accumulation apparatus or converted by the conversion unit. If the temporary content accumulation apparatus does not store a moving image stream or a moving image file receivable by the content-requesting-terminal, the gateway requests the external delivery server to transmit a moving image content specified in the request message, instructs the conversion unit to execute conversion into a moving image stream or a moving image file receivable by the content-requesting-terminal, transmits the converted moving image stream or the converted moving image file to the terminal, and stores the converted moving image stream or the converted moving image file in the predetermined temporary content accumulation apparatus.

According to a second aspect of the present invention, there is provided a gateway. The gateway comprises: a capability information storage unit storing information about a terminal type included in a content request message and capability information about moving image content reception capability of a terminal of the type, the information being associated with each other; a control signal transmission and reception unit extracting, based on capability information obtained from type information included in a request message supplied from a content-requesting-terminal via a packet transfer apparatus, a moving image stream or a moving image file receivable by the content-requesting-terminal from a predetermined temporary content accumulation apparatus; a conversion unit that, by referring to information stored in the capability information storage unit, executes necessary conversion on a moving image stream or a moving image file storing the moving image stream supplied from an external delivery server; and a packet transmission unit transmitting a moving image stream or a moving image file extracted from the predetermined temporary content accumulation apparatus or converted by the conversion unit. If the temporary content accumulation apparatus does not store a moving image stream or a moving image file receivable by the content-requesting-terminal, the gateway requests the external delivery server to transmit a moving image content specified in the request message, instructs the conversion unit to execute conversion into a moving image stream or a moving image file receivable by the content-requesting-terminal, transmits the converted moving image stream or the converted moving image file to the terminal, and stores the converted moving image stream or the converted moving image file in the predetermined temporary content accumulation apparatus.

According to a third aspect of the present invention, there is provided a delivery method using the above gateway. Namely, the delivery method comprises: causing the gateway to request, if the temporary content accumulation apparatus does not store a moving image stream or a moving image file receivable by the content-requesting-terminal, the external delivery server to transmit a moving image content specified in the request message; and causing the gateway to instruct the conversion unit to execute conversion into a moving image stream or a moving image file receivable by the content-requesting-terminal, to transmit the converted moving image stream or the converted moving image file to the terminal, and to store the converted moving image stream or the converted moving image file in the predetermined temporary content accumulation apparatus. This method is associated with a certain machine, that is, with the above gateway.

According to a fourth aspect of the present invention, there is provided a program causing a computer forming the above gateway to execute the processings of: requesting, if the temporary content accumulation apparatus does not store a moving image stream or a moving image file receivable by the content-requesting-terminal, the external delivery server to transmit a moving image content specified in the request message; instructing the conversion unit to execute conversion into a moving image stream or a moving image file receivable by the content-requesting-terminal; and transmitting the converted moving image stream or the converted moving image file to the terminal and storing the converted moving image stream or the converted moving image file in the predetermined temporary content accumulation apparatus. This program can be recorded in a computer-readable storage medium. Namely, the present invention can be realized as a computer program product.

The meritorious effects of the present invention are summarized as follows without limitation.

According to the present invention, even when the number of requesting terminals is large or even when a flood of requests for certain content is transmitted from many terminals, the content can suitably be delivered on the basis of capability of each terminal. In addition, the present invention does not require the terminals to transmit, for example, screen display capability or attribute information. This is because the present invention uses type information that is included in a request message transmitted when deliver of content is requested and includes a temporary content accumulation apparatus that accumulates converted content therein. In this way, if a terminal of the same type transmits a delivery request, the content can be delivered from the temporary content accumulation apparatus.

### BRIEF DESCRIPTION OF THE DRAWINGS

FIG. 1 is a block diagram illustrating a connection configuration according to a first exemplary embodiment of the present invention.

FIG. 2 is a block diagram illustrating a configuration of a gateway according to the first exemplary embodiment of the present invention.

FIG. 3 is a block diagram illustrating a configuration of a gateway according to a second exemplary embodiment of the present invention.

FIG. 4 is a block diagram illustrating a connection configuration according to a third exemplary embodiment of the present invention.

### PREFERRED MODES

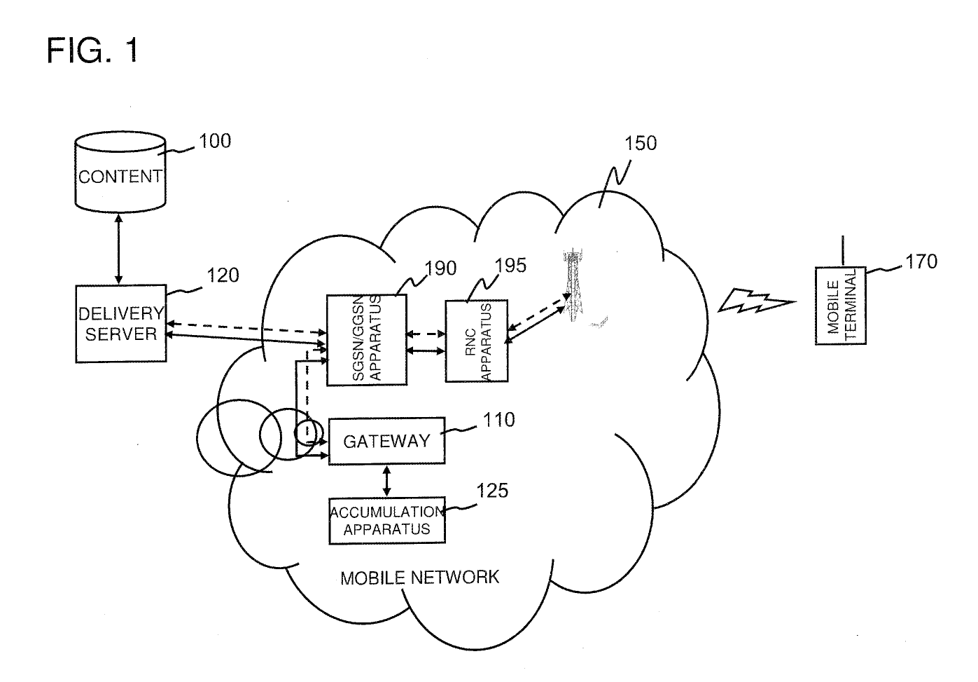

First, a summary of the present invention will be described. The present invention can be realized by arranging a gateway 110 and an accumulation apparatus 125 that serves as a temporary content accumulation apparatus in a mobile network 150 that delivers content to a mobile terminal 170, as illustrated in FIG. 1. The accumulation apparatus 125 is not necessarily arranged as a separate apparatus from the gateway 110. For example, the accumulation apparatus 125 can be arranged as a memory incorporated in the gateway 110 or as an auxiliary storage apparatus. The reference symbols of the drawings in this summary are merely used as examples to facilitate understanding of the present invention. Therefore, the present invention is not limited by the modes illustrated in the drawings.

When the gateway 110 according to the present invention receives a content request message from the mobile terminal 170 via a packet transfer apparatus (corresponds to an SGSN/GGSN apparatus 190 in FIG. 1), the gateway 110 acquires terminal type information and content information included in the request message and determines whether the accumulation apparatus 125 stores a compressed and encoded moving image stream or moving image file that corresponds to the content information and that is receivable by the content-requesting-terminal determined by the type information in terms of capability of the terminal.

If, as a result of the determination, it is determined that the accumulation apparatus 125 stores a compressed and encoded moving image stream or moving image file that corresponds to the content information and that is receivable by the terminal, the gateway 110 extracts the moving image stream or moving image file from the accumulation apparatus 125 and transmits the extracted moving image stream or moving image file to the mobile terminal 170 via the packet transfer apparatus.

However, if, as a result of the determination, it is determined that the accumulation apparatus 125 does not store a compressed and encoded moving image stream or moving image file that corresponds to the content information and that is receivable by the terminal, the gateway 110 requests a delivery server 120 to transmit relevant content. If necessary, the gateway 110 converts the content based on the terminal type information, so that the content matches capability of the terminal. After the conversion, the gateway 110 accumulates the moving image stream or moving image file in the accumulation apparatus 125 and transmits the moving image stream or moving image file to the mobile terminal 170 via the packet transfer apparatus.

Subsequently, if the gateway 110 receives a request for the same content from a terminal of the same type of the mobile terminal 170, the gateway 110 can extract the moving image stream or moving image file accumulated in the accumulation apparatus 125 and can deliver the extracted moving image stream or moving image file. Thus, even if the number of requesting terminals is large or even if a flood of requests for popular content is transmitted from many terminals, it is possible to prevent extension of the turn-around time (TAT), congestion in the mobile network 150, or occurrence of packet loss.

In addition, it is preferable that the gateway 110 be configured to acquire information about the maximum bit rate and/or information about a guaranteed bit rate as bearer QoS information and determine whether the bit rate of the delivered moving image stream or moving image file exceeds the maximum bit rate or the guaranteed bit rate. If, as a result of the determination, it is determined that the bit rate of the delivered moving image stream or moving image file exceeds the maximum bit rate or the guaranteed bit rate, the gateway 110 executes conversion to reduce the bit rate. In this way, occurrence of packet loss or the like in the mobile terminal 170 can be prevented more reliably. If the number of requesting terminals is large or if a flood of requests for popular content is transmitted from many terminals, such conversion can improve the meritorious effect of preventing extension of the turn-around time (TAT), congestion in the mobile network 150, or occurrence of packet loss.

According to the present invention, the following modes are possible.

[Mode 1]

Mode 1 provides the delivery system according to the first aspect.

[Mode 2]

It is preferable that the gateway acquire a maximum bit rate and/or a guaranteed bit rate of a bearer from the packet transfer apparatus. In addition, it is preferable that, if the moving image stream or the moving image file that is accumulated in the temporary content accumulation apparatus and that is receivable by the content-requesting-terminal has a bit rate exceeding the acquired bit rate, the gateway instruct the conversion unit to execute conversion to reduce the bit rate so that the bit rate of the moving image stream or the moving image file falls below the acquired bit rate, transmit the converted moving image stream or the converted moving image file to the terminal, and store the converted moving image stream or the converted moving image file in the predetermined temporary content accumulation apparatus.

[Mode 3]

It is preferable that the capability information further comprise a receivable bit rate, codec, screen resolution, and frame rate of a terminal of the type. In addition, it is preferable that the conversion unit comprise a transcoder unit generating a moving image stream or a moving image file matching the capability information.

[Mode 4]

It is preferable that the capability information further comprise at least one of a receivable file format, file size, and protocol of a terminal of the type. In addition, it is preferable that the conversion unit comprise a file conversion unit executing conversion into a file matching the capability information or a protocol conversion unit executing conversion into a protocol matching the capability information.

[Mode 5]

It is preferable that the packet transfer apparatus be an xGSN (Serving/Gateway GPRS Support Node) apparatus in a mobile packet network or an S/P (Serving/Packet Data) gateway in a mobile EPC (Evolved Packet Core) network.

[Mode 6]

Mode 6 provides the gateway according to the second aspect.

[Mode 7]

Mode 7 provides the content delivery method according to the third aspect.

[Mode 8]

Mode 8 provides the program according to the fourth aspect.

[Mode 9]

The delivery system according to the first aspect can comprise: the gateway according to the second aspect; a packet transfer apparatus transferring a request message supplied from a content-requesting-terminal to the gateway; and a temporary content accumulation apparatus in which a moving image stream or a moving image file converted by the gateway is stored.

[Mode 10]

The delivery system can comprise a radio network control apparatus selecting a radio base station in an area in which the content-requesting-terminal is located and transmitting a packet storing the moving image stream or the moving image file to the content-requesting-terminal.

### First Exemplary Embodiment

Next, a first exemplary embodiment of the present invention will be described in detail with reference to the drawings.

FIG. 1 is a block diagram illustrating a connection configuration according to the first exemplary embodiment of the present invention. FIG. 1 illustrates a configuration including: a delivery server 120 delivering content 100; a mobile terminal 170; an RNC (Radio Network Controller) apparatus 195; a gateway 110 connected to an SGSN/GGSN(Serving GPRS Support Node/Gateway GPRS Support Node) apparatus 190 in a mobile network 150; and an accumulation apparatus 125 connected to the gateway 110. In FIG. 1, solid lines with arrows represent flows of data and dashed lines with arrows represent flows of control signals.

The mobile network 150 may be any one of a mobile packet network, a WiMax (Worldwide Interoperability for Microwave Access) network, and an LTE (Long Term Evolution) network. In this example, a mobile packet network is used.

The delivery server 120 delivers a compressed-and-encoded moving image stream or moving image file of content that includes at least one of a moving image, a still image, audio, and voice, as the content 100.

The gateway 110 receives a connection request message from the mobile terminal 170 via the RNC apparatus 195 and the SGSN/GGSN apparatus 190 arranged in the mobile packet network 150 and acquires mobile terminal type information included in the connection request message. In this example, HTTP (Hyper Text Transfer Protocol) is used as a protocol for this connection request message. However, alternatively, SIP (Session Initiation Protocol) or the like may be used. The gateway 110 may acquire the type information from a content request message, instead of from the connection request message.

In addition, after acquiring the type information, the gateway 110 acquires content information specified in a content request message. Next, based on the content information, the gateway 110 determines whether the accumulation apparatus 125 accumulates a compressed-and-encoded moving image stream or a file storing the moving image stream that corresponds to the requested content and that is receivable by the same type.

If, as a result of the determination, it is determined that the accumulation apparatus 125 accumulates the moving image stream or moving image file receivable by the content-requesting-mobile terminal 170, the gateway 110 extracts the moving image stream or moving image file from the accumulation apparatus 125 and transmits the moving image stream or moving image file to the mobile terminal 170 via the SGSN/GGSN apparatus 190.

However, if, as a result of the determination, it is determined that the accumulation apparatus 125 does not accumulate the moving image stream or moving image file viewable by the content-requesting-mobile-terminal 170, the gateway 110 requests the delivery server 120 to transmit the corresponding content via the SGSN/GGSN apparatus 190. Subsequently, the gateway 110 uses capability information corresponding to the type information and converts the moving image stream or moving image file into a format receivable by the mobile terminal 170 with the highest quality. Next, the gateway 110 accumulates the converted moving image stream or moving image file in the accumulation apparatus 125 and transmits the converted moving image stream or moving image file to the mobile terminal 170 via the SGSN/GGSN apparatus 190.

The SGSN/GGSN apparatus 190 uses a GTP (GPRS Tunneling Protocol) protocol to transfer the moving image stream or moving image file outputted from the delivery server 120 to the gateway 110 and uses an Iu-PS protocol to output the moving image stream or moving image file outputted from the gateway 110 to the RNC apparatus 195.

The RNC apparatus 195 uses a TCP/IP protocol or the like to select a radio base station in an area in which the mobile terminal 170 is located and transmit packets storing the moving image stream or moving image file to the mobile terminal 170 via the radio base station.

The mobile terminal 170 receives the moving image file or moving image stream transmitted via the mobile network 150 and decodes, reproduces, and displays the moving image file or moving image stream. As radio functions, the mobile terminal 170 can use not only W-CDMA (Wideband Code Division Multiple Access) or CDMA2000 but also HSDPA (High Speed Downlink Packet Access), HSPA+ (High Speed Packet Access), LTE (Long Term Evolution), WiMax, or the like.

In addition, while a single gateway 110 is connected to a single SGSN/GGSN apparatus in FIG. 1, a single gateway 110 may be connected to and coordinated with a plurality of SGSN/GGSN apparatuses.

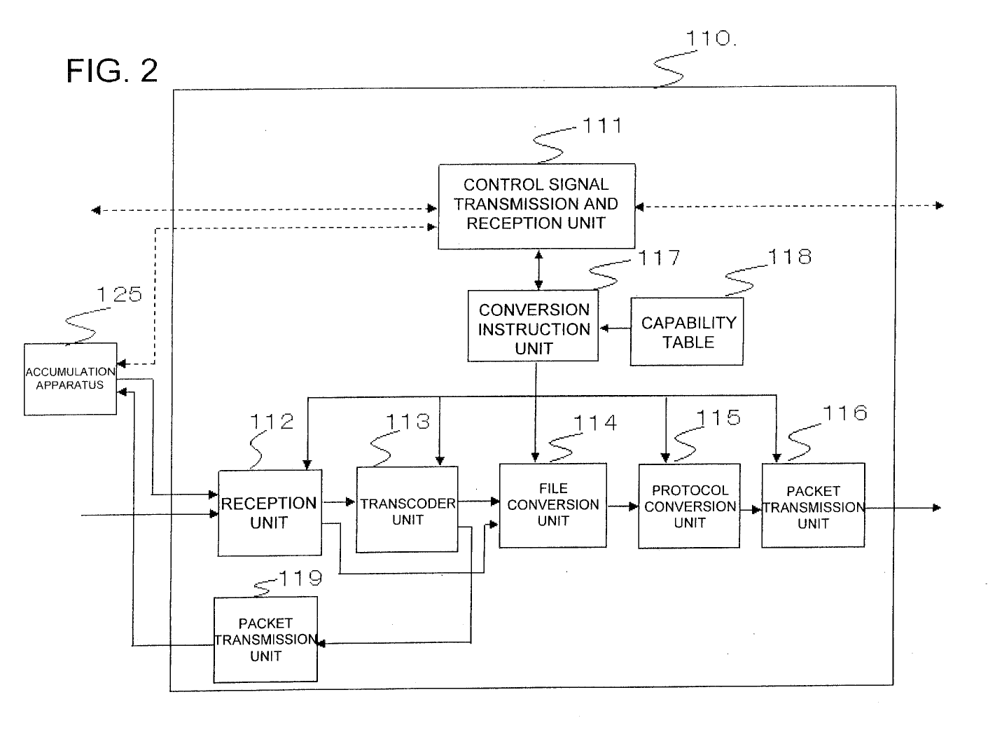

FIG. 2 is a block diagram illustrating a configuration of the gateway according to the first exemplary embodiment of the present invention. In FIG. 2, the gateway 110 according to the present exemplary embodiment includes a control signal transmission and reception unit 111, a reception unit 112, a transcoder unit 113, a file conversion unit 114, a protocol conversion unit 115, packet transmission units 116 and 119, a conversion instruction unit 117, and a capability table 118. The transcoder unit 113, the file conversion unit 114, the protocol conversion unit 115, and the conversion instruction unit 117 correspond to the above conversion unit.

The control signal transmission and reception unit 111 receives a request signal from the mobile terminal 170 via a certain protocol via the RNC apparatus 195 and the SGSN/GGSN apparatus 190. In this example, HTTP (Hyper Text Transfer Protocol) is used as the protocol from the mobile terminal 170. In the case of HTTP, the control signal transmission and reception unit 111 acquires type information from a User Agent header and outputs the acquired type information to the conversion instruction unit 117. Alternatively, other than HTTP, a widely known protocol such as SDP (Session Description Protocol) may be used as the certain protocol.

The capability table 118 stores a correspondence table in which type information about terminals and capability information about the corresponding terminal types is associated with each other. Namely, the capability table 118 serves as a capability information storage unit. For example, capability information such as (1) an acceptable codec, (2) a screen resolution, (3) a frame rate, (4) a receivable maximum bit rate, (5) a receivable file format and file size, and (6) a reception protocol is associated with each type in the capability table 118.

Based on the content information and type information specified in the request message transmitted from the mobile terminal 170 that has received a selection operation for moving image content desired by the user after the connection request, the control signal transmission and reception unit 111 accesses the accumulation apparatus 125 to determine whether the accumulation apparatus 125 accumulates a compressed-and-encoded moving image stream or a moving image file storing the compressed-and-encoded moving image stream that corresponds to the specified content and that is receivable by the same type.

As a result of the determination, if the control signal transmission and reception unit 111 determines that the accumulation apparatus 125 accumulates a compressed-and-encoded moving image stream or a moving image file storing the moving image stream that corresponds to the requested content and that is receivable by the type, the control signal transmission and reception unit 111 instructs the accumulation apparatus 125 to read the moving image stream or moving image file and instructs the transcoder unit 113 to bypass processing thereof.

In accordance with the above instructions (if the accumulation apparatus 125 accumulates the corresponding content), the reception unit 112 extracts a stream part from the moving image stream or moving image file extracted from the accumulation apparatus 125 and outputs the extracted stream part to the file conversion unit 114, bypassing the transcoder unit 113.

In accordance with the receivable file format and file size in the above (5) in the capability information about the mobile terminal 170 outputted from the conversion instruction unit 117, the file conversion unit 114 converts the moving image stream supplied from the reception unit 112 to generate a file having a file format and file size receivable by the type of the mobile terminal 170. Examples of the file format include a 3GPP file format, a 3GPP2 file format, and an MP4 file format. For example, details of the 3GPP file format can be found in 3GPP TS26.244 standards.

In accordance with the receivable protocol in the above (6) in the capability information included in the instructions from the conversion instruction unit 117, the protocol conversion unit 115 determines a protocol that can be used by the mobile terminal 170. Through this protocol, the protocol conversion unit 115 outputs the file outputted from the file conversion unit 114 to the packet transmission unit 116. There are protocols such as RTP/UDP and HTTP/TCP. However, in accordance with the instructions from the conversion instruction unit 117, for example, HTTP/TCP/IP is used.

The packet transmission unit 116 adds appropriate headers to the file supplied via the file conversion unit 114 and the protocol conversion unit 115 and transmits the file to the SGSN/GGSN apparatus 190 as packets.

As a result of the determination, if it is determined that the accumulation apparatus 125 does not accumulate a compressed-and-encoded moving image stream or a moving image file storing the moving image stream that corresponds to the requested content and that is receivable by the type, the control signal transmission and reception unit 111 uses a protocol such as SIP (Session Initiation Protocol) or RTSP (Real Time Streaming Protocol) and requests the delivery server 120 to transmit content via the SGSN/GGSN apparatus 190.

Upon receiving the request, the delivery server 120 (see FIG. 1) uses RTP packets or the like and transmits a compressed-and-encoded moving image stream or moving image file corresponding to the requested content to the gateway 110 via the SGSN/GGSN apparatus 190. In addition, by using a protocol such as SDP (Session Description Protocol), the delivery server 120 transmits information about the content to the gateway 110 via the SGSN/GGSN apparatus 190. For example, the information represents a codec, an image screen resolution, a bit rate, a frame rate, and whether the content is transmitted as a stream or a file, used when the selected content is compressed and encoded.

The control signal transmission and reception unit 111 outputs the information about the selected content, such as a codec, transmitted from the delivery server 120 to the conversion instruction unit 117. The conversion instruction unit 117 determines whether to convert the moving image stream or moving image file supplied from the delivery server 120, based on the capability information obtained from the type information about the mobile terminal 170 and the content information supplied from the control signal transmission and reception unit 111.

As a result of the determination, if it is determined that the moving image stream or moving image file needs to be converted, the conversion instruction unit 117 determines what conversion needs to be executed and gives instructions to the transcoder unit 113 for the conversion.

Next, the conversion will be described based on an example, in which the delivery server 120 supplies information representing that the content is compressed and encoded based on MPEG-2 MP (Main Profile), 8 Mbps, a screen resolution of SD (720×480 pixels), and a frame rate of 30 fps and in which the capability table 118 supplies information representing that the type has the capability that enables H.264 encoding based on 512 kbps, a screen resolution of QVGA (320×240 pixels), and a frame rate of 30 fps.

In this case, the conversion instruction unit 117 creates conversion instructions and outputs the instructions to the transcoder unit 113 and the like, so that the transcoder unit 113 and the like executes decoding based on MPEG-2 MP, converts the screen resolution from SD to QVGA, and executes encoding based on H.264, 512 kbps, and 30 fps. In addition, the conversion instruction unit 117 outputs the capability information read from the capability table 118 to the packet transmission unit 119, the file conversion unit 114, the protocol conversion unit 115, and the packet transmission unit 116.

Upon receiving a moving image stream or moving image file from the delivery server 120, the reception unit 112 outputs the moving image stream or moving image file to the transcoder unit 113. If the reception unit 112 receives a moving image file from the delivery server 120, the reception unit 112 extracts a stream stored in the file. If the reception unit 112 receives the moving image stream from the delivery server 120, the reception unit 112 extracts a stream stored in a packet payload.

In accordance with the conversion instructions from the conversion instruction unit 117, the transcoder unit 113 activates a transcoder that operates on a real-time basis, converts the inputted stream, and outputs the converted stream to the packet transmission unit 119 and the file conversion unit 114. For example, in the case of the above conversion instructions, decoding is executed based on MPEG-2 MP, the screen resolution is converted from SD to QVGA, and encoding is executed based on H.264, 512 kbps, and 30 fps.

The packet transmission unit 119 outputs the converted stream supplied from the transcoder unit 113 in the form of packets to the accumulation apparatus 125, along with the content information (conversion instructions) and the type information supplied from the conversion instruction unit 117.

The accumulation apparatus 125 accumulates the converted stream, along with the content information (conversion instructions) and the type information outputted from the packet transmission unit 119.

In accordance with the receivable file format and file size in the above (5) in the capability information about the mobile terminal 170 outputted from the conversion instruction unit 117, for the moving image stream outputted from the transcoder unit 113, the file conversion unit 114 generates a file having a file format and file size receivable by the type of the mobile terminal 170. Next, the file conversion unit 114 outputs the file to the protocol conversion unit 115. Examples of the file format include a 3GPP file format, a 3GPP2 file format, an MP4 file format, and a flash file.

In accordance with the receivable protocol in the above (6) in the capability information included in the instructions from the conversion instruction unit 117, the protocol conversion unit 115 determines a protocol that can be used by the mobile terminal 170. Through this protocol, the protocol conversion unit 115 outputs the file outputted from the file conversion unit 114 to the packet transmission unit 116. There are protocols such as RTP/UDP and HTTP/TCP. However, in accordance with the instructions from the conversion instruction unit 117, for example, HTTP/TCP/IP is used.

The packet transmission unit 116 adds appropriate headers to the file supplied via the file conversion unit 114 and the protocol conversion unit 115 and transmits the file to the SGSN/GGSN apparatus 190 as packets.

Thus, according to the present exemplary embodiment, the gateway automatically distinguishes various types of mobile terminals (mobile phone terminals, PDAs, mobile PCs, video game machines, and the like) and automatically executes conversion suitable for a selected type on the content (conversion of the bit rate, resolution, codec, frame rate, file format, protocol, and the like). In this way, the same content can be delivered to various types of terminals, without requiring modification of the mobile terminals.

In addition, according to the present exemplary embodiment, even when the number of requesting terminals is large, a plurality of gateways are arranged in a network, or a flood of accesses to popular content is caused, converted content can be delivered from the accumulation apparatus 125. Thus, extension of the turn-around time (TAT) can be prevented. In addition, since QoS (Quality of Service) of the mobile network between the delivery server and the terminals can be assured, traffic congestion and packet loss can be prevented.

### Second Exemplary Embodiment

Next, a second exemplary embodiment of the present invention will be described in detail with reference to the drawings. In the second exemplary embodiment, the above gateway according to the first exemplary embodiment is changed.

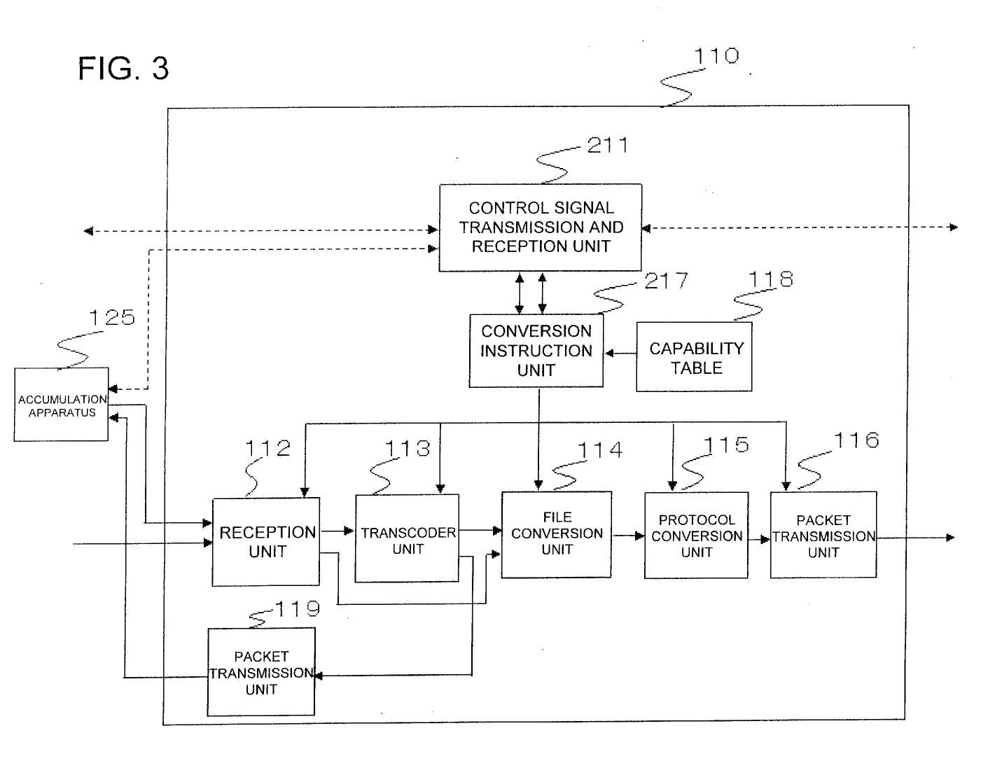

FIG. 3 is a block diagram illustrating a configuration of a gateway according to the second exemplary embodiment of the present invention. In FIG. 3, a gateway 110 according to the present exemplary embodiment includes a control signal transmission and reception unit 211, the reception unit 112, the transcoder unit 113, the file conversion unit 114, the protocol conversion unit 115, the packet transmission units 116 and 119, a conversion instruction unit 217, and the capability table 118. In FIG. 3, since constituent elements denoted by the same reference characters as those in FIG. 2 operate in the same way as those according to the first exemplary embodiment, description of the same constituent elements will be omitted. Hereinafter, the difference between the first and second exemplary embodiments will be described.

The present exemplary embodiment is different from the first exemplary embodiment in that the control signal transmission and reception unit 211 includes a function of acquiring bearer QoS (Quality of Service) information set in the RNC apparatus 195 by the SGSN/GGSN apparatus 190 from the SGSN/GGSN apparatus 190 and that the conversion instruction unit 217 gives conversion instructions by using the QoS information.

Examples of the bearer QoS information about the mobile network 150 include a QoS Class Identifier (QCI), a maximum bit rate (MBR), and a guaranteed bit rate (GBR). In this example, the maximum bit rate (MBR) and the guaranteed bit rate (GBR) are acquired.

as in the above first exemplary embodiment, based on the content information and type information specified by a request message transmitted from the mobile terminal 170, the control signal transmission and reception unit 211 accesses the accumulation apparatus 125 and determines whether the accumulation apparatus 125 accumulates a compressed-and-encoded moving image stream or a moving image file storing the compressed-and-encoded moving image stream that corresponds to the same content and that is receivable by the same type. In addition, the control signal transmission and reception unit 211 refers to the QoS information to determine whether, the compressed-and-encoded moving image stream or a moving image file storing the compressed-and-encoded moving image stream, if transmitted without change, is viewable and audible by the mobile terminal 170 with no problem. If the compressed-and-encoded moving image stream or a moving image file storing the compressed-and-encoded moving image stream has a bit rate equal to or less than the maximum bit rate (MBR) and the guaranteed bit rate (GBR) and is viewable and audible by the mobile terminal 170 with no problem even if transmitted without change, the operation as described in the first exemplary embodiment will be executed.

However, if the accumulation apparatus 125 does not accumulate a compressed-and-encoded moving image stream or a moving image file storing the compressed-and-encoded moving image stream that corresponds to the same content and that is receivable by the same type or while the accumulation apparatus 125 accumulates such stream or file, if the stream or file is not viewable and audible without change, the control signal transmission and reception unit 211 outputs type information from the terminal, information about the content delivered from the delivery server 120, and information about the maximum bit rate and the guaranteed bit rate as bearer QoS information.

First, as in the above first exemplary embodiment, the conversion instruction unit 217 compares capability information obtained from the type information with the information about the content to determine whether conversion needs to be executed on the content transmitted from the delivery server 120. If the content needs to be converted, the conversion instruction unit 217 determines what conversion needs be executed by the transcoder unit 113.

For example, assuming that the delivery server 120 supplies information representing that the content is compressed and encoded based on MPEG-2 MP (Main Profile), 8 Mbps, a screen resolution of SD (720×480 pixels), and a frame rate of 30 fps and that the capability table 118 supplies information representing that the type has the capability that enables H.264 encoding based on 512 kbps, a screen resolution of QVGA (320×240 pixels), and a frame rate of 30 fps, the conversion instruction unit 217 creates conversion instructions, so that the transcoder unit 113 and the like executes decoding based on MPEG-2 MP, converts the screen resolution from SD to QVGA, and executes encoding based on H.264, 512 kbps, and 30 fps, as in the first exemplary embodiment.

In addition, the conversion instruction unit 217 according to the present exemplary embodiment refers to the maximum bit rate information and the guaranteed bit rate information as bearer QoS information and corrects the conversion instructions so that the bit rate does not exceed these rates. For example, if the maximum bit rate information represents 512 kbps and the guaranteed bit rate information represents 256 kbps, the conversion instruction unit 217 uses the smaller rate, that is, the guaranteed bit rate information, as a reference. Namely, the conversion instruction unit 217 changes the bit rate in the above conversion instructions to 256 kbps. In addition, the conversion instruction unit 217 may execute additional correction, such as reduction of the frame rate to 15 fps.

As a result, the transcoder unit 113 converts the input stream, in accordance with the conversion instructions in view of the bearer QoS information.

As described above, according to the present exemplary embodiment in which the gateway 110 and the packet transfer apparatus in the mobile network 150 coordinate with each other about the bearer QoS, the bit rate of the content transmitted to the mobile terminal 170 does not exceed the maximum bit rate or the guaranteed bit rate set in the bearer QoS. Thus, degradation of quality can be prevented. For example, the image on the terminal side does not freeze, an excessive amount of time is not required to update the image, or the voice is not interrupted.

According to the above second exemplary embodiment, both the maximum bit rate information and the guaranteed bit rate information is used. However, of course, only one of the information can be used. In addition, if a QoS Class Identifier (QCI) can be acquired as the bearer QoS information, the bit rate or frame rate can be decreased appropriately in accordance with the QCI value.

### Third Exemplary Embodiment

Next, a third exemplary embodiment of the present invention will be described in detail with reference to the drawings. In the third exemplary embodiment, the mobile network is changed.

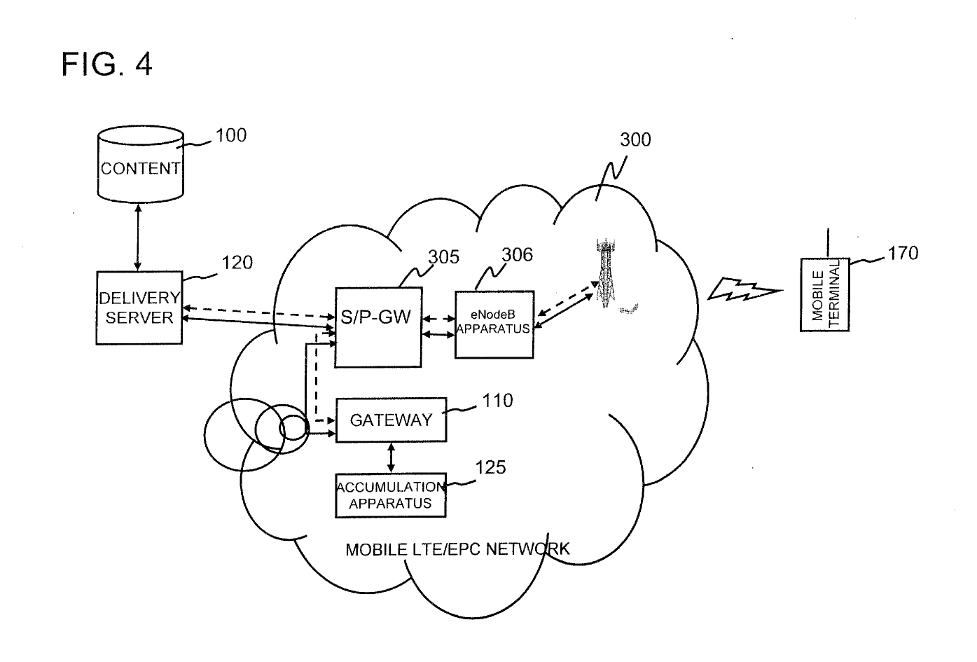

FIG. 4 is a block diagram illustrating a connection configuration according to the third exemplary embodiment of the present invention. In FIG. 4, since constituent elements denoted by the same reference characters as those in FIG. 1 are the same constituent elements as those according to the first exemplary embodiment, description thereof will be omitted. Hereinafter, the difference between the first and third exemplary embodiments will be described.

In FIG. 4, the gateway 110 and the accumulation apparatus 125 are arranged in a mobile LTE (Long Term Evolution)/EPC (Enhanced Packet Core) network 300.

An S/P-GW (Serving/Packet data GateWay) 305 in FIG. 4 serves as a packet transfer apparatus and uses EPC technology to realize high-speed packet transfer. More specifically, in the mobile LTE/EPC network 300, the S/P-GW 305 receives a moving image stream or moving image file transferred from the gateway 110 through a protocol such as the UDP/IP or TCP/IP protocol, executes conversion into the GTP-U (GPRS Tunneling Protocol-User Plane)/UDP/IP protocol, and transmits the moving image stream or moving image file to an eNodeB (Enhanced-NodeB) apparatus 306.

The eNodeB apparatus 306 in FIG. 4 uses LTE technology to realize high-speed packet transfer in radio areas. More specifically, the eNodeB apparatus 306 converts a moving image stream or moving image file transmitted from the S/P-GW 305 into the PDCP (Packet Data Convergence Protocol)/RLC (Radio Link Control) protocol and transmits packets storing the moving image stream or moving image file to the mobile terminal 170.

The mobile terminal 170 receives the above moving image stream or moving image file transmitted via the mobile LTE/EPC network 300 and decodes, reproduces, and displays the moving image stream or moving image file.

Since the S/P-GW 305 and the gateway 110 are connected to each other by the IP protocol, the gateway 110 connected to the S/P-GW apparatus can have the configuration illustrated in FIG. 2 or 3.

In FIG. 4, while a single gateway is connected to and coordinated with a single S/P-GW apparatus, a single gateway may be connected to and coordinated with a plurality of S/P-GW apparatuses.

Thus, as illustrated in each of the exemplary embodiments, according to the present invention, the cache of content necessary for the gateway 110 is automatically created and accumulated in the temporary content accumulation apparatus 125. Thus, even when the number of requesting terminals is large or even when a flood of requests for certain content is transmitted from many terminals, the content can suitably be delivered in accordance with capability of each of the individual terminals. In addition, screen display capability, attribute information, and the like do not need to be transmitted from the terminal side, modification and the like are not necessary on the terminal side.

While preferred exemplary embodiments of the present invention have thus been described, the present invention is not limited to the above exemplary embodiments. Further variations, substitutions, or adjustments are possible within the scope of the basic technical concept of the present invention. For example, while the above exemplary embodiments have been described based on an example where compressed-and-encoded moving image content is delivered, the present invention is applicable to delivering content such as still images and audio signals, by using the same configuration.

In addition, other than MPEG-2, another widely known codec such as H.264 or WMV (Windows (registered mark) Multimedia Video) can be used as a codec to compress and encode moving image content. Thus, in the transcoder unit 113, other than MPEG-4, a widely known codec such as H.264 or WMV is used as an after-conversion codec.

In addition, other than 3GPP, another widely known file format such as 3GPP2 or MP4 can be used as an after-conversion file format in the file conversion unit 114.

In addition, another widely known protocol such as RTP can be used as an after-conversion protocol in the protocol conversion unit 115. Variations and adjustments of the exemplary embodiments and examples are possible within the scope of the overall disclosure (including the claims) of the present invention and based on the basic technical concept of the present invention. Various combinations and selections of various disclosed elements are possible within the scope of the claims of the present invention. That is, the present invention of course includes various variations and modifications that could be made by those skilled in the art according to the overall disclosure including the claims and the technical concept.

### EXPLANATIONS OF SYMBOLS

100 content
110 gateway
111, 211 control signal transmission and reception unit
112 reception unit
113 transcoder unit
114 file conversion unit
115 protocol conversion unit
116, 119 packet transmission unit
117, 217 conversion instruction unit
118 capability table
120 delivery server
125 (temporary content) accumulation apparatus
150 mobile network
170 mobile terminal
190 SGSN/GGSN apparatus
195 RNC apparatus
300 mobile LTE/EPC network
305 S/P-GW
306 eNodeB apparatus

1. A gateway, comprising:
a capability information storage unit storing information about a terminal type included in a content request message and capability information about moving image content reception capability of a terminal of the type, the information being associated with each other;
a control signal transmission and reception unit extracting, based on capability information obtained from type information included in a request message supplied from a content-requesting-terminal via a packet transfer apparatus, a moving image stream or a moving image file receivable by the content-requesting-terminal from a predetermined temporary content accumulation apparatus;
a conversion unit that, by referring to information stored in the capability information storage unit, executes necessary conversion on a moving image stream or a moving image file storing the moving image stream supplied from an external delivery server; and
a packet transmission unit transmitting a moving image stream or a moving image file extracted from the predetermined temporary content accumulation apparatus or converted by the conversion unit;
wherein, if the temporary content accumulation apparatus does not store a moving image stream or a moving image file receivable by the content-requesting-terminal, the gateway requests the external delivery server to transmit a moving image content specified in the request message, instructs the conversion unit to execute conversion into a moving image stream or a moving image file receivable by the content-requesting-terminal, transmits the converted moving image stream or the converted moving image file to the terminal, and stores the converted moving image stream or the converted moving image file in the predetermined temporary content accumulation apparatus.

2. A gateway according to claim 1;
wherein the gateway acquires a maximum bit rate and/or a guaranteed bit rate of a bearer from the packet transfer apparatus; and
wherein, if the moving image stream or the moving image file that is accumulated in the temporary content accumulation apparatus and that is receivable by the content-requesting-terminal has a bit rate exceeding the acquired bit rate, the gateway instructs the conversion unit to execute conversion to reduce the bit rate so that the bit rate of the moving image stream or the moving image file falls below the acquired bit rate, transmits the converted moving image stream or the converted moving image file to the terminal, and stores the converted moving image stream or the converted moving image file in the predetermined temporary content accumulation apparatus.

3. The gateway according to claim;
wherein the capability information further comprises a receivable bit rate, codec, screen resolution, and frame rate of a terminal of the type; and
wherein the conversion unit comprises a transcoder unit generating a moving image stream or a moving image file matching the capability information.

4. The gateway according to claim 1;
wherein the capability information further comprises at least one of a receivable file format, file size, and protocol of a terminal of the type; and
wherein the conversion unit comprises a file conversion unit executing conversion into a file matching the capability information or a protocol conversion unit executing conversion into a protocol matching the capability information.

5. The gateway according to claim 1;
wherein the packet transfer apparatus is an xGSN (Serving/Gateway GPRS Support Node) apparatus in a mobile packet network or an S/P (Serving/Packet Data) gateway in a mobile EPC (Evolved Packet Core) network.

6. A delivery system, comprising:
the gateway according to claim 1;
at least one packet transfer apparatus transferring a request message supplied from a content-requesting-terminal to the gateway; and
a temporary content accumulation apparatus in which a moving image stream or a moving image file converted by the gateway is stored.

7. The delivery system according to claim 6, further comprising:
a radio network control apparatus selecting a radio base station in an area in which the content-requesting-terminal is located and transmitting a packet storing the moving image stream or the moving image file to the content-requesting-terminal.

8. A content delivery method, comprising:
using a gateway comprising:
a capability information storage unit storing information about a terminal type included in a content request message and capability information about moving image content reception capability of a terminal of the type, the information being associated with each other;
a control signal transmission and reception unit extracting, based on capability information obtained from type information included in a request message supplied from a content-requesting-terminal via a packet transfer apparatus, a moving image stream or a moving image file receivable by the content-requesting-terminal from a predetermined temporary content accumulation apparatus;
a conversion unit that, by referring to information stored in the capability information storage unit, executes necessary conversion on a moving image stream or a moving image file storing the moving image stream supplied from an external delivery server; and
a packet transmission unit transmitting a moving image stream or a moving image file extracted from the predetermined temporary content accumulation apparatus or converted by the conversion unit;
causing the gateway to request, if the temporary content accumulation apparatus does not store a moving image stream or a moving image file receivable by the content-requesting-terminal, the external delivery server to transmit a moving image content specified in the request message; and
causing the gateway to instruct the conversion unit to execute conversion into a moving image stream or a moving image file receivable by the content-requesting-terminal, to transmit the converted moving image stream or the converted moving image file to the terminal, and to store the converted moving image stream or the converted moving image file in the predetermined temporary content accumulation apparatus.

9. The content delivery method according to claim 8;
wherein the gateway acquires a maximum bit rate and/or a guaranteed bit rate of a bearer from the packet transfer apparatus; and
wherein, if the moving image stream or the moving image file that is accumulated in the temporary content accumulation apparatus and that is receivable by the content-requesting-terminal has a bit rate exceeding the acquired bit rate, the gateway instructs the conversion unit to execute conversion to reduce the bit rate so that the bit rate of the moving image stream or the moving image file falls below the acquired bit rate, transmits the converted moving image stream or the converted moving image file to the terminal, and stores the converted moving image stream or the converted moving image file in the predetermined temporary content accumulation apparatus.

10. (canceled)

11. The gateway according to claim 2;
wherein the capability information further comprises a receivable bit rate, codec, screen resolution, and frame rate of a terminal of the type; and
wherein the conversion unit comprises a transcoder unit generating a moving image stream or a moving image file matching the capability information.

12. The gateway according to claim 2;
wherein the capability information further comprises at least one of a receivable file format, file size, and protocol of a terminal of the type; and
wherein the conversion unit comprises a file conversion unit executing conversion into a file matching the capability information or a protocol conversion unit executing conversion into a protocol matching the capability information.

13. The gateway according to claim 3;
wherein the capability information further comprises at least one of a receivable file format, file size, and protocol of a terminal of the type; and
wherein the conversion unit comprises a file conversion unit executing conversion into a file matching the capability information or a protocol conversion unit executing conversion into a protocol matching the capability information.

14. The gateway according to claim 2;
wherein the packet transfer apparatus is an xGSN (Serving/Gateway GPRS Support Node) apparatus in a mobile packet network or an S/P (Serving/Packet Data) gateway in a mobile EPC (Evolved Packet Core) network.

15. The gateway according to claim 3;
wherein the packet transfer apparatus is an xGSN (Serving/Gateway GPRS Support Node) apparatus in a mobile packet network or an S/P (Serving/Packet Data) gateway in a mobile EPC (Evolved Packet Core) network.

16. The gateway according to claim 4;
wherein the packet transfer apparatus is an xGSN (Serving/Gateway GPRS Support Node) apparatus in a mobile packet network or an S/P (Serving/Packet Data) gateway in a mobile EPC (Evolved Packet Core) network.
